(19) United States
(12) Patent Application Publication
(10) Pub. No.: US 2003/0089409 A1
(43) Pub. Date: May 15, 2003

(54) Valve device with check valve, used for washer nozzle and hose joint

(76) Inventor: Hirotaka Morimoto, Hamamatsu-City (JP)

Correspondence Address: POSZ & BETHARDS, PLC, 11250 ROGER BACON DRIVE, SUITE 10, RESTON, VA, 20190, US

(21) Appl. No.: 10/291,407

(22) Filed: Nov. 12, 2002

(30) Foreign Application Priority Data
Nov. 14, 2001 (JP) 2001-348330
Aug. 20, 2002 (JP) 2002-239569

(51) Int. Cl. F16K 15/14

(52) U.S. Cl. 137/859

(57) ABSTRACT

A valve device with a check valve can be used for a washer nozzle and a hose joint. In the valve device, first and second body portions are detachably attached to each other by an attachment of a joint portion to a joint hole and by an engagement of engagement protrusions with engagement holes. A circular fixing portion of the check valve is clamped between the first and second body portions, thereby sealing an attachment portion between the first and second body portions. Further, the check valve includes plural connection portions connected to the fixing portion at a radial inside to be elastically deformed, and a valve body connected to the connection portions to open and close a supply port of the first body portion. Accordingly, the valve device has a simple structure, and it is possible to perform a maintenance in the valve device.

### CROSS-REFERENCE TO RELATED APPLICATION

This application is related to and claims priority from Japanese Patent Applications No. 2001-348330 filed on Nov. 14, 2001 and No. 2002-239569 filed on Aug. 20, 2002, the contents of which are hereby incorporated by reference.

### BACKGROUND OF THE INVENTION

1. Field of the Invention

The present invention relates to a valve device with a check valve for preventing a reverse flow of a liquid fluid. The valve device can be suitably used for a washer nozzle for jetting a cleaning liquid, and a hose joint for joining a supply hose and a discharge hose.

2. Description of Related Art

Generally, a washer nozzle for washing a windshield includes a check valve for preventing a reverse flow of a cleaning liquid, or a hose joint used for a cleaning liquid supply includes the check valve for preventing the reverse flow of the cleaning liquid. The washer nozzle with the check valve or the hose joint with the check valve is formed by ultrasonic welding and the like for ensuring seal performance of the washer nozzle or the hose joint.

However, after the washer nozzle or the hose joint is formed, it is difficult to be disassembled, and the check valve cannot be maintained and repaired. For example, when foreign matters are clogged in the washer nozzle or the hose joint, it is difficult to be removed. Because a part of components constructing the washer nozzle or the hose joint cannot be exchanged, all the washer nozzle or all the hose joint is discarded when being failed. Further, since the conventional check valve is constructed by plural separated components more than two, the number of assembling processes is increased in the check valve, thereby increasing production cost.

### SUMMARY OF THE INVENTION

In view of the above problems, it is an object of the present invention to provide a valve device with a check valve, which can perform a maintenance such as a repair of the check valve, and is produced in low cost while having sealing performance with a simple structure. The valve device can be suitably used for a washer nozzle with a check valve, and for a hose joint with a check valve.

According to the present invention, when the valve device is used for the washer nozzle, the washer nozzle includes a nozzle body having a first body portion and a second body portion which are detachably attached to each other to define a fluid passage through which a liquid fluid such as a cleaning liquid flows. The first body portion includes a supply port from which the cleaning liquid is supplied into the nozzle body, and the second body portion includes a discharge port from which the supplied cleaning liquid is discharged. The supply port and the discharge port communicate with each other through the fluid passage. A check valve is disposed in the fluid passage for preventing the cleaning liquid from flowing from the water passage into the supply port, and for enabling the cleaning liquid to flow from the supply port into the water passage. The check valve includes an annular fixing portion, a plurality of connection portions extending from the fixing portion toward a radial inside of the fixing portion at plural positions of the fixing portions, a valve body connected to and supported by the connection portions to open and close the supply port, and a flow passage penetrate through the check valve. The annular fixing portion is clamped and fixed between the first body portion and the second body portion attached to each other for sealing an attachment portion between the first and second body portions. The valve body closes the supply port by contacting a periphery of the supply port, and can be separated from the supply port by a flow pressure of the cleaning liquid supplied from the supply port, larger than a predetermined pressure. Accordingly, when the cleaning liquid is supplied to the supply port, the valve body is separated from the supply port, so that the cleaning liquid flows from the supply port into the fluid passage through the flow passage provided in the check valve to penetrate through the check valve, and is discharged from the discharge port. When the cleaning liquid is not supplied to the supply port, the valve body closes the supply port, thereby preventing the cleaning liquid from flowing from the supply port to the fluid passage. Thus, when a liquid pump for pumping the liquid fluid such as the cleaning liquid is stopped, the cleaning liquid can be prevented from leaking from the supply port while the cleaning liquid is filled in the fluid passage, thereby improving jetting responsibility of the washer nozzle. Further, the nozzle body is constructed by the first body portion having the supply port and the second body portion having the discharge port, and the fixing portion of the check valve is clamped and fixed between the first and second bodies attached to each other to seal the attachment portion therebetween. Therefore, sealing performance between the first and second body portions can be ensured even when the first body portion and the second body portion are attached through the fixing portion without bonding such as ultrasonic welding and the like. Thus, even after the first and second body portions are attached to each other, they can be disassembled, and maintenance such as a repair of the check valve can be readily performed. In addition, in the washer nozzle, the number of components constructing the check valve can be reduced, and the number of assembling processes can be reduced, thereby decreasing production cost.

When the valve device is used for a hose joint, a joint body for joining a supply hose and a discharge hose includes the first body portion and the second body portion, and the check valve is disposed in the fluid passage of the joint body. Even when the valve device of the present invention is used for the hose joint, the structure is similar to the above-described structure, and advantage similar to that of the above described washer nozzle can be obtained.

Preferably, the first body portion includes a first engagement portion, the second body portion includes a second engagement portion being engaged with the first engagement portion. In this case, when the first body portion and the second body portion are attached to each other, the first engagement portion and the second engagement portion are engaged with each other, and the fixing portion is elastically clamped and fixed between the first body portion and the second body portion. Therefore, the sealing performance between the first body portion and the second body portion can be readily obtained with a simple structure.

Further, the first body portion includes a valve seat around the support port, and the supply port is closed when the valve body contacts the valve seat. Therefore, line contact can be performed between the valve body and the valve seat, and pressure-contact performance between the valve body and the valve seat can be improved. In this case, the fixing portion is clamped and fixed between the first body portion and the second body portion at a position displaced toward the first body portion with respect to the contact position between the valve body and the valve seat in an axial direction of the fluid passage. Therefore, the connection portion of the check valve is in a slight extension state, and a contraction force of the connection portion is applied to the valve body so that the valve body can tightly close the supply port when the flow pressure of the liquid fluid is not applied to the supply port.

### BRIEF DESCRIPTION OF THE DRAWINGS

Additional objects and advantages of the present invention will be more readily apparent from the following detailed description of preferred embodiments when taken together with the accompanying drawings, in which:

FIG. 1 is a partly-sectional front view showing a main part of a washer nozzle with a check valve, when a washer pump is stopped, according to a first embodiment of the present invention;

FIG. 2 is a partly-sectional front view showing the main part of the washer nozzle with the check valve when the washer pump is operated, according to the first embodiment;

FIG. 3 is a disassembled perspective view showing the washer nozzle with the check valve, according to the first embodiment;

FIG. 4 is a bottom view showing a joint portion of an upper body of the washer nozzle with the check valve, according to the first embodiment;

FIG. 5 is a perspective view showing an O-ring valve in the washer nozzle, according to the first embodiment;

FIG. 6 is a cross-sectional view showing a hose joint with a check valve, when a washer pump is stopped, according to a second embodiment of the present invention;

FIG. 7 is a cross-sectional view showing the hose joint with the check valve, when the washer pump is operated, according to the second embodiment; and

FIG. 8 is a schematic diagram showing a windshield washing unit including the hose joint with the check valve, according to the second embodiment.

### DETAILED DESCRIPTION OF THE PRESENTLY PREFERRED EMBODIMENTS

Preferred embodiments of the present invention will be described hereinafter with reference to the appended drawings.

First Embodiment

In the first embodiment, a valve device of the present invention is typically used for a washer nozzle with a check valve.

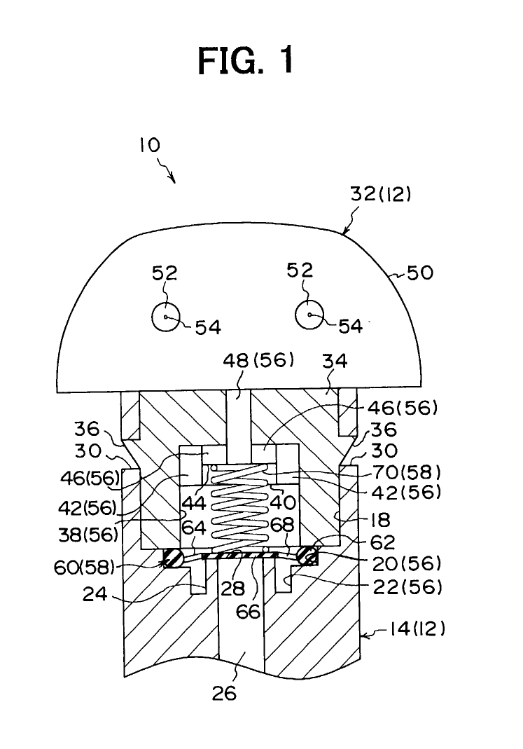

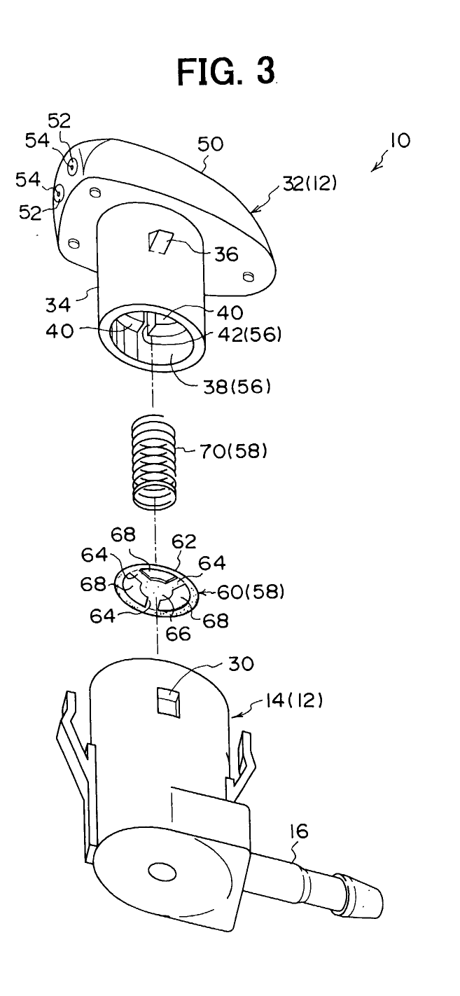

As shown in FIGS. 1-3, a washer nozzle 10 with a check valve (washer valve) 58 according to the first embodiment includes a nozzle body 12. The nozzle body 12 is disposed on a vehicle body near a windshield (not shown) such as a bonnet. The nozzle body 12 includes an approximate cylindrical lower body portion 14 at a lower side portion, and the lower body portion 14 includes a supply pipe 16 at a lower side portion. The supply pipe 16 is connected to a washer pump (not shown), attached to a washer tank (not shown) disposed in an engine compartment and the like, through a hose piping. A cleaning liquid (liquid fluid) is contained in the washer tank, and is press-sent into the lower body portion 14 through the hose piping and the supply pipe 16.

A joint hole 18 having an approximate cylindrical shape is formed in the lower body portion 14 at its upper portion, and a cylindrical clamp hole 20 is formed in the lower body portion 14 directly below the joint hole 18. A diameter of the clamp hole 20 is set smaller than a diameter of the joint hole 18. A cylindrical valve-seat hole 22 is formed in the lower body 14 directly below the clamp hole 20, and a diameter of the valve seat hole 22 is set smaller than the diameter of the clamp hole 20. A cylindrical valve seat 24 is formed in the valve seat hole 22, and is disposed at a radial center area of the joint hole 18, the clamp hole 20 and the valve seat hole 22. A lower end of the valve seat 24 is integrated to a bottom surface of the valve seat hole 22, and an upper end of the valve seat 24 protrudes to an upper side from a bottom surface of the clamp hole 20, that is, to a side of an upper body portion 32 described later.

A cylindrical supply passage 26 is formed in the lower body portion 14 along its center axis, and communicates with the supply pipe 16 at a lower side. An inner peripheral surface of the valve seat 24 defines an upper portion of the supply passage 26. A circular top end opening of the supply passage 26 is used as a supply port 28. That is, a top end of the valve seat 24 defines the circular supply port 28. Therefore, when the cleaning liquid is press-sent into the lower body portion 14 through the supply pipe 16, the cleaning liquid is supplied to the supply port 28 through the supply passage 26. Plural (e.g., two in the first embodiment) quadrangular engagement holes 30 (latch hole) are formed as engagement portions in the lower body portion 14 at the upper side portion, and are disposed at intervals in a circumferential direction of the lower body portion 14. The engagement holes 30 penetrate through a wall surface of the lower body portion 14 to communicate with the joint hole 18 in the lower body portion 14.

The nozzle body 12 further includes the upper body portion 32 at an upper side portion, and the upper body portion 32 includes a joint portion 34 having an approximate cylindrical shape at a lower side portion. Plural (e.g., two in the first embodiment) triangle engagement protrusions 36 (latch protrusions) are formed on an outer peripheral surface of the joint portion 34 as engagement portions to be engaged with the engagement holes 30 of the lower body portion 14. The plural engagement protrusions 36 are disposed at intervals in a circumferential direction of the joint portion 34 at positions corresponding to the engagement holes 30. The joint portion 34 of the upper body portion 32 is fitted into the joint hole 18 of the lower body portion 14 so that a bottom surface of the joint portion 34 contacts a bottom surface of the joint hole 18. At this time, the engagement protrusions 36 are inserted in and engaged (snap-fitted) with the engagement holes 30, so that the upper body portion 32 and the lower body portion 14 are attached to each other. A dimension between the bottom surface of the joint portion 34 and the bottom surface of the clamp hole 20 is set smaller than a diameter of a fixing portion 62 described later. An upper surface of each engagement protrusion 36 is set horizontally, to be fitted to an upper surface of each engagement hole 30, thereby preventing the engagement protrusion 36 from removing from the engagement hole 30. Since a lower surface of each engagement protrusion 36 is obliquely formed, the engagement protrusions 36 are guided by their tilted lower surfaces, so that the joint portion 34 is readily inserted into the joint hole 18.

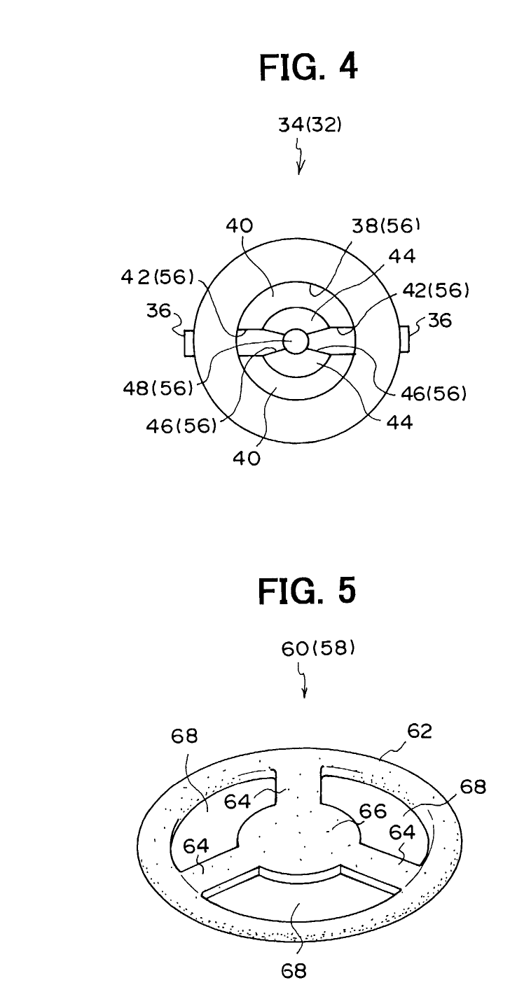

FIG. 4 is a bottom view showing the joint portion 34 of the upper body 32. As shown in FIG. 4, a cylindrical inlet hole 38 is formed in the joint portion 34 at the lower portion, and a step wall 40 is formed in the inlet hole 38 at the upper portion to have an approximate cylindrical shape. An outer peripheral surface of the step wall 40 is integrated to an inner peripheral surface defining the inlet hole 38. Plural (e.g., two in the first embodiment) step wall holes 42 are formed in the step wall 40, and each step wall hole 42 penetrates through the step wall 40 in a direction parallel to the axial direction of the joint portion 34. Further, a support wall 44 is formed into an approximate cylindrical shape in the inlet hole 38 at an upper side of the step wall 40, and an outer periphery of the support wall 44 is integrated to an inner periphery of the of the step wall 40. Plural (e.g., two in the first embodiment) support wall holes 46 are formed in the support wall 40 to penetrate through the support wall 44 in a direction parallel to the axial direction of the joint portion 34. The support wall holes 46 provided in the support wall 44 communicate with the step wall holes 42 provided in the step wall 40, respectively.

A communication passage 48 is formed in the joint portion 34 at its upper portion in the axial direction, and a lower side of the communication passage 48, defined by an inner periphery of the support wall 44, communicates with the support wall holes 46. The upper body portion 32 includes an approximate half-conical injection portion 50 at an upper side, and the injection portion 50 is integrated to the joint portion 34. The injection portion 50 includes plural (e.g., two in the first embodiment) nozzle jets 52, and each nozzle jet 52 includes an injection ports 54. The injection ports 54 face the windshield, and communicate with an upper portion of the communication passage 48 through an introduction passage (not shown) provided in the injection portion 50. A water passage 56 is constructed by the clamp hole 20, the seat valve hole 22, the inlet hole 38 including the step wall holes 42 and the support wall holes 46, the communication passage 48 and the introduction passage. The supply port 28 and the injection ports 54 communicate with each other through the water passage 56.

A check valve 58 is disposed in the water passage 56 of the nozzle body 12. The check valve 58 includes an O-ring valve 60 shown in FIG. 5, and a compression coil spring 70. The O-ring valve 60 is integrally formed by an elastic material (e.g., rubber in the first embodiment), and includes a ring fixing portion 62. The fixing portion 62 is fitted in the clamp hole 20 of the lower body portion 14, and is clamped and fixed between a bottom surface of the joint portion 34 and a bottom surface of the clamp hole 20. Thus, the fixing portion 62 fixes the O-ring valve 60 in the lower body portion 14 and the upper body portion 32, and seals an assembling portion between the joint hole 18 of the lower body portion 14 and the joint portion 34 of the upper body portion 32. The fixing portion 62 is elastically deformed by the bottom surface of the joint portion 34 and the bottom surface of the clamp hole 20, and is fitted to and clamped by the bottom surface of the joint portion 34 and the bottom surface of the clamp hole 20. Plural (e.g., three in the first embodiment) plate-like connection portions 64 are integrated to the fixing portion 62, and extend from the fixing portion 62 to a radial inside of the fixing portion 62 at plural positions of the fixing portion 62. The connection portions 64 are disposed at intervals in a circumferential direction of the fixing portion 62. The connection portions 64 are integrated to a circular valve body 66, and support the valve body 66. The valve body 66 contacts the valve seat 24 around the supply port 28, thereby closing the supply port 28. The fixing portion 62 is set at a position displaced toward the lower body portion 14, relative to a contact position between the valve body 66 and the valve seat 24. The O-ring valve 64 defines therein a flow passage 68 between the fixing portion 62, the connection portions 64 and the valve body 66. The flow passage 62 is provided in the O-ring valve 64 to penetrate through the O-ring valve 64 in the direction parallel to the center axial direction.

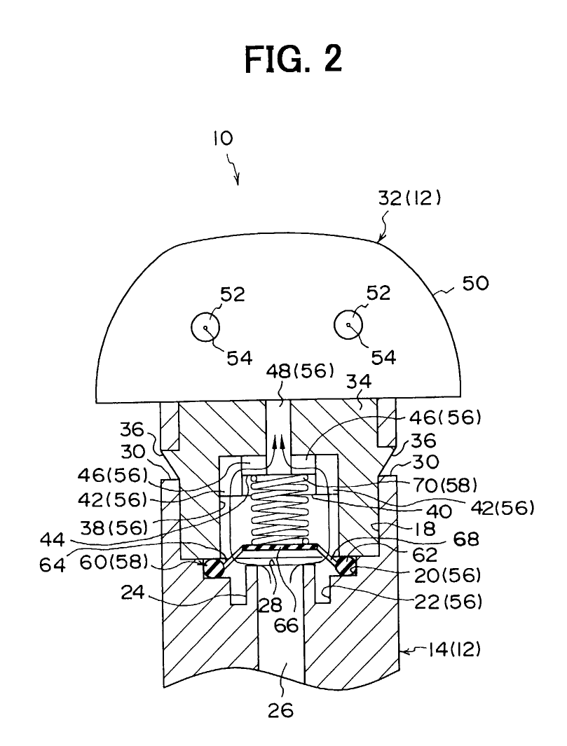

An upper end of the compression coil spring 70 contacts the support wall 44, and is supported by the support wall 44. A lower end of the compression coil spring 70 contacts the valve body 66 of the O-ring valve 60, and presses the valve body 66 toward the supply port 28. As shown in FIG. 2, when the cleaning liquid is supplied to the supply port 28, the valve body 66 is pushed upwardly to be separated from the supply port 28 by flow pressure of the cleaning liquid, larger than a predetermined pressure. Then, the cleaning liquid flows from the supply port 28 into the water passage 56 through the flow passage 68 of the O-ring valve 60, and is jetted from the injection ports 54 toward the windshield.

Next, operation of the first embodiment will be described. When the washer pump attached to the washer tank is driven, the cleaning liquid is supplied from the washer tank to the supply port 28 through the hose piping, the supply pipe 16 and the supply passage 26 of the blower body 14. Therefore, when the flow pressure of the cleaning liquid becomes larger than a closing force (predetermined pressure) of the valve body 66 for closing the supply port 28, the compression coil spring 70 is contracted by the flow pressure of the cleaning liquid while the connection portions 64 are extended by the flow pressure. Then, the valve body 66 is separated from the supply port 28 and moves upwardly. Thus, the cleaning liquid flows into the water passage 56 through the flow passage 68 of the O-ring valve 60, and is injected from the injection ports 54. The cleaning liquid is injected to the windshield, so that the windshield is washed by the cleaning liquid. Here, the closing force of the valve body 66 for closing the supply port 28 includes elastic force of the connection portions 64 and biasing force of the compression coil spring 70.

When the washer pump is stopped, acceleration force is applied to the cleaning liquid stored in the hose piping due to vibrations of a vehicle and its turn, and the cleaning liquid may leak from the injection ports 54. However, in the first embodiment, when the washer pump is stopped, no cleaning liquid is supplied to the supply port 28, and the valve body 66 closes the supply port 28, thereby preventing the cleaning liquid from flowing from the supply port 28 into the water passage 56. Accordingly, when the washer pump is stopped, the cleaning liquid can be prevented from leaking from the injection ports 54. Further, in the first embodiment, the cleaning liquid can be maintained in a state where the cleaning liquid is filled in the water passage 56, the supply passage 26, the supply pipe 16 and the hose piping. Since the supply port 28 is closed by the valve body 66, air can be prevented from flowing into the hose piping from the injection ports 54. When the washer pump is restarted and the cleaning liquid is press-sent, the valve body 66 can be immediately pushed upwardly. That is, a passed time, from the start of the washer pump to the cleaning liquid injection of the washer nozzle 10 can be made shorter, thereby improving injection responsibility. The injection responsibility is defined by shortness of a passed time from injection command operation to cleaning liquid injection.

In the first embodiment, the nozzle body 12 is formed by assembling the lower body portion 14 having the supply port 28 and the upper body portion 32 having the injection ports 54 to each other. The lower body portion 14 and the upper body portion 32 are attached to each other by the insert of the joint portion 34 into the joint hole 18 and by the engagement of the engagement protrusions 36 with the engagement holes 30. Further, the fixing portion 62 of the O-ring valve 60 is clamped and fixed between the bottom surface of the joint portion 34 and the bottom surface of the clamp hole 20, so that the attachment portion between the joint hole 18 of the lower body portion 14 and the joint portion 34 of the upper body portion 32 are sealed. Therefore, the lower body portion 14 and the upper body portion 32 are not required to be bonded by ultrasonic welding and the like. Without this bonding, the O-ring valve 60 can be fixed into the nozzle body 12 through the fixing portion 62 while sealing performance in the nozzle body 12 can be ensured. Thus, even after the lower body portion 14 and the upper body portion 32 are assembled with each other, they can be disassembled from each other by disengagement of the engagement protrusions 36 from the engagement holes 30 and by detachment of the joint portion 34 from the joint hole 18. Accordingly, the check valve 58 and the like in the nozzle body 12 can be maintained and repaired. For example, foreign matters clogged in the water passage 56, the supply passage 26 and the supply pipe 16 can be removed in the maintenance. That is, a portion of components constructing the washer nozzle 10 can be exchanged, and the other components can be used as they are without discarding all of the washer nozzle 10.

The fixing portion 62, the connection portions 64 and the valve body 66 of the O-ring valve 60 are integrally molded by using an elastic material. When the upper body portion 32 and the lower body portion 14 are assembled with each other, the engagement protrusions 36 of the upper body portion 32 are engaged with the engagement holes 30 of the lower body portion 14, and the fixing portion 62 is elastically deformed to be fitted and clamped between the bottom surface of the joint portion 34 and the bottom surface of the clamp hole 20. Therefore, the fixation 62 can be accurately fixed in the nozzle body 12 while surely sealing the attachment portion between the lower body portion 14 and the upper body portion 32 due to the elastic deformation of the fixing portion 62. The engagement protrusions 36 can be engaged with the engagement holes 30 without a movement due to restoring force of the elastic deformation of the fixing portion 62. Therefore, the upper body portion 32 and the lower body portion 14 can be assembled with each other without a movement, thereby preventing the attachment therebetween from becoming deficient. The deformation state, where the fixing portion 62 is elastically deformed to be fitted and clamped between the joint portion 34 and the surface of the clamp hole 20, can be maintained by the engagement between the engagement protrusions 36 and the engagement holes 30. Therefore, the sealing performance of the nozzle body 12 can be effectively maintained.

The fixing portion 62 of the O-ring valve 60 is clamped and fixed between the bottom surface of the clamp hole 20 and the bottom surface of the joint portion 34 to be displaced toward the lower body portion 14 from the contact position between the valve body 66 and the valve seat 24. Therefore, the connection portions 64 of the O-ring valve 60 are extended, the valve body 66 can be pressed to the valve seat 24 due to contraction force of the connection portions 64. When the valve body 66 contacts the valve seat 24 around the supply port 28, the valve body 66 is fitted to the top end shape of the valve seat 24 and the peripheral shape of the supply port 28, due to the contraction of the valve body 66. Accordingly, the supply port 28 can be surely closed, and the cleaning liquid can be surely prevented from flowing from the supply port 28 into the water passage 56 when the washer pump is stopped. Since the valve body 66 of the O-ring valve 60 contacts the valve seat protruding around the supply port 28, line contact can be substantially set between the valve seat 24 and the valve body 66. Therefore, between the valve seat 24 and the valve body 66, contact pressure is increased, and fit performance is improved. Thus, the supply port 28 can be more surely closed, and the cleaning liquid can be more surely prevented from flowing from the supply port 28 into the water passage 56 when the washer pump is stopped.

Since the compression coil spring 70, disposed in the water passage 56, presses the valve body 66 toward the supply port 28, the supply port 28 can be rapidly and accurately closed by the valve body 66. In the first embodiment, the check valve 58 is constructed by only the O-ring valve 60 and the compression coil spring 70, the number of components and the number of assembling processes can be reduced, thereby reducing production cost. If the valve body 66 of the O-ring valve 60 can sufficiently close the supply port 28 only by elastic force of the connection portion 64 of the O-ring valve 60 when the washer pump is stopped, the compression coil spring 70 is not required, and the check valve 58 may be constructed only by the O-ring valve 60. In this case, the compression coil spring 70 can be omitted, and the number of components and the number of assembling processes of the check valve 58 can be further reduced, thereby further reducing production cost.

Second Embodiment

In the second embodiment, the present invention is typically applied to a hose joint with the check valve.

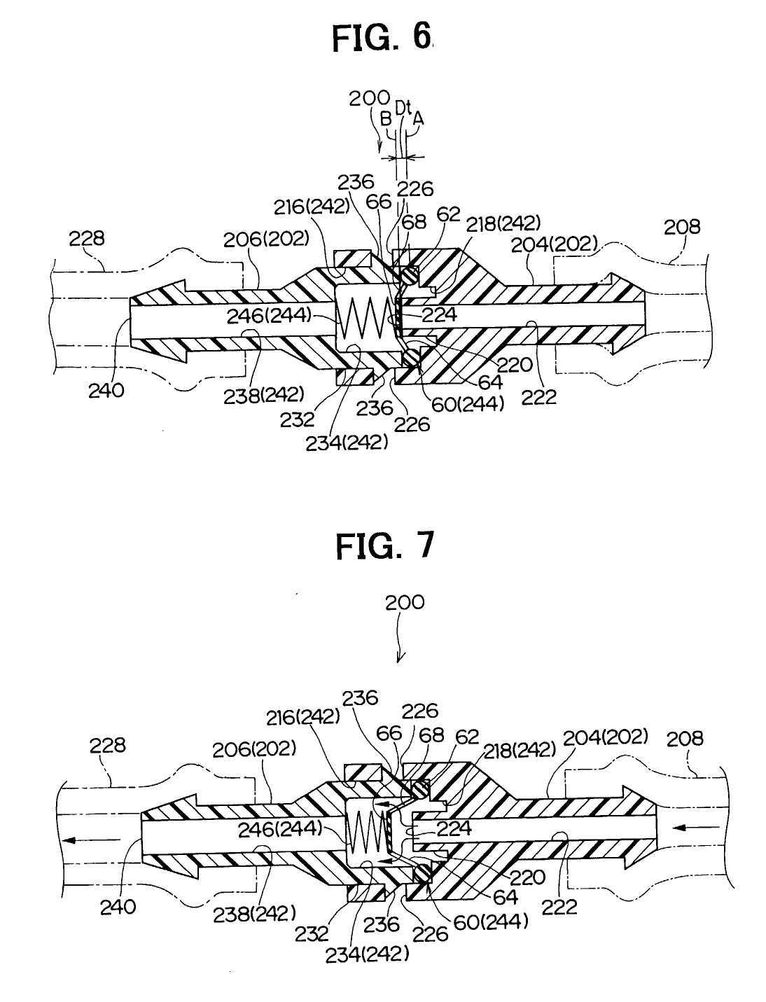

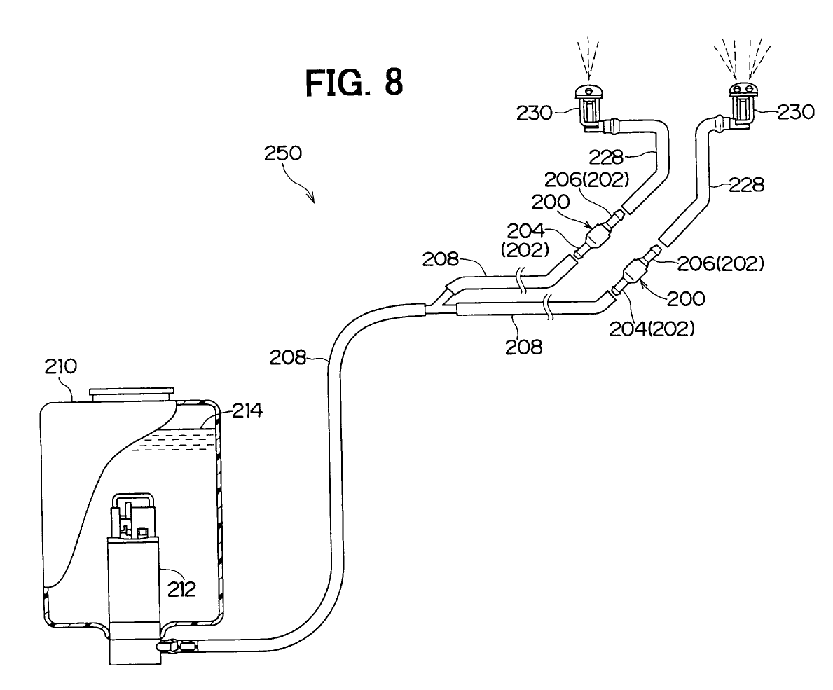

As shown in FIGS. 6 and 7, a hose joint 200 with a check valve 244 includes a joint body 202, and the joint body 202 includes a supply body portion 204 and a discharge body portion 206. Each of the supply body portion 204 and the discharge body portion 206 is formed into an approximate cylindrical shape. In the second embodiment, the hose joint 200 is typically used for a windshield washing unit 250 shown in FIG. 8. As shown in FIG. 8, one end of the supply body portion 204 is connected to one end of a supply hose 208, and the other end of the supply hose 208 is connected to a washer pump 212 attached to a washer tank 210 disposed in the engine compartment or the like. A cleaning liquid 214 (liquid fluid) is filled in the washer tank 210, and is press-sent by operation of the washer pump 212 from the washer tank 210 to the supply body portion 204 through the supply hose 208. As shown in FIGS. 6 and 7, a joint hole 216 having an approximate cylindrical shape is formed in the supply body portion 204 at its other end, and a cylindrical valve-seat hole 218 is formed in the supply body portion 204 at one end of the joint hole 216. A diameter of the valve seat hole 218 is set smaller than a diameter of the joint hole 216. A cylindrical valve seat 220 is formed in the valve seat hole 218, and is disposed at a center side of the joint hole 216 and the valve seat hole 218. A bottom end of the valve seat 220 is integrated to a bottom surface defining the valve seat hole 218. Further, a top end of the valve seat 220 is located at the other end side of the supply body portion 204, that is, at a side of the discharge body portion 206 with respect to a bottom surface of the joint hole 216.

A cylindrical supply passage 222 is formed in the supply body portion 204 along in a center axial direction, and one end of the supply passage 222 communicates with the supply hose 208. A circular supply port 224 is provided at the other end of the supply passage 222 defined by an inner circumferential surface of the valve seat 220. Therefore, when the cleaning liquid 214 is press-sent to the supply body portion 204 through the supply hose 208, the cleaning liquid 214 is supplied to the supply port 224 through the supply passage 222. Plural (e.g., two in the second embodiment) quadrangular engagement holes 226 used as engagement portions are formed in the supply body portion 204. The plural engagement holes 226 are disposed at intervals in an outer circumferential direction of the supply body portion 204, and communicate with the joint hole 216.

One end of the discharge body portion 206 is connected to one end of a discharge hose 228, and the other end of the discharge hose 228 is connected to a washer nozzle 230 disposed on the bonnet and the like around the windshield. The discharge body portion 206 includes a joint portion 232 formed approximately cylindrically, at the other end. The joint portion 232 has a cylindrical receiving hole 234 therein. The joint portion 232 includes plural (e.g., two in the second embodiment) engagement protrusions 236 protruding from an outer peripheral surface, and the engagement protrusions 236 each having a triangular cross-section correspond to the engagement holes 226, respectively. The engagement protrusions 236 are disposed at intervals in a circumferential direction of the discharge body portion 206. The engagement protrusions 236 are inserted into and engaged (snap-fitted) with the engagement holes 226 while the joint portion 232 of the discharge body portion 206 is fitted to the joint hole 216 of the supply body portion 204. Thus, the supply body portion 204 and the discharge body portion 206 are assembled with each other. At this time, a clearance between a top end surface of the joint portion 232 and a bottom surface of the joint hole 216 is set to be smaller than the diameter of the fixing portion 62 of the O-ring valve 60 described in the first embodiment. A surface of each engagement protrusion 236 at a one end side of the discharge body portion 206 is set vertically, and is fitted to a side surface of each engagement hole 226, thereby preventing the engagement protrusion 236 from removing from the engagement hole 226, and preventing the joint portion 232 from removing from the joint hole 216. Since a surface of each engagement protrusion 236 at the other end side of the discharge body portion 206 is obliquely set, the insertion of the engagement protrusions 236 into the joint hole 216 are guided by the oblique surfaces of the engagement protrusions 236.

A cylindrical discharge passage 238 is formed in the discharge body portion 206 along the center axial direction. A circular discharge port 240 provided at one end of the discharge passage 238 communicates with the discharge hose 228. The other end of the discharge passage 238 communicates with the receiving hole 234. A diameter of the discharge passage 238 is set smaller than a diameter of the receiving hole 234. A water passage 242 is constructed by the joint hole 216, the valve seat hole 218, the receiving hole 234 and the discharge passage 238, so that the supply port 224 and the discharge port 240 communicate with each other through the water passage 242. The check valve 244 of the second embodiment is disposed in the water passage 242 of the joint body 202. As in the first embodiment, the check valve 244 includes the O-ring valve 60 shown in FIG. 5, and the fixing portion 62 of the O-ring valve 60 is attached into the joint hole 216. The fixing portion 62 is clamped and fixed between the top surface of the joint portion 232 and the bottom surface of the joint hole 216. Thus, the O-ring valve 60 is fixed to the joint body 202 through the fixing portion 62, and the fixing portion 62 seals an attachment portion between the joint hole 216 of the supply body portion 204 and the joint portion 232 of the discharge body portion 206. The fixing portion 62 is elastically deformed by the top surface of the joint portion 232 and the bottom surface of the joint hole 216, and is fitted and clamped between both the top surface of the joint portion 232 and the bottom surface of the joint hole 216.

The valve body 66 of the O-ring valve 60 contacts the valve seat 220 around the supply port 224 to close the supply port 224 as shown in FIG. 6. A clamped and deformed position A of the fixing portion 62 is set to be displaced from a contact position B between the valve body 66 and the valve seat 220 toward the supply body portion 204, by a dimension Dt. The check valve 244 further includes a compression coil spring 246. One end of the compression coil spring 246 contacts the bottom surface of the receiving hole 234, and is supported in the bottom surface of the receiving hole 234. The other end of the compression coil spring 246 contacts the valve body 66 of the O-ring valve 60, and presses the valve body 66 to the side of the supply port 224. As shown in FIG. 7, when the cleaning liquid 214 is supplied to the supply port 224, the valve body 66 is pushed to be separated from the supply port 224 by flow pressure of the cleaning liquid 214. Then, the cleaning liquid 214 flows from the supply port 224 into the water passage 242 through the flow passage 68 of the O-ring valve 60, and is discharged from discharge port 240 to the discharge hose 228. Thus, the cleaning liquid 214 is injected to the windshield from the washer nozzle 230 through the discharge hose 228.

In the windshield washer unit 250 shown in FIG. 8, the supply hose 208 is branched into plural (e.g., two in the second embodiment) hoses each having the hose joint 200, and each hose joint 200 is connected to the discharge hose 228. Each discharge hose 228 is connected to a washer nozzle 230 without a check valve. Preferably, the hose joint 200 is connected to the discharge hose 228 at a position around the washer nozzle 230.

Next, operation according to the second embodiment will be described. When the washer pump 212 attached to the washer tank 210 is driven, the cleaning liquid 214 is supplied from the washer tank 210 to the supply port 224 through the supply hose 208 and the supply passage 222 of the supply body portion 204. At this time, when the flow pressure of the cleaning liquid 214 becomes larger than a closing force of the valve body 66 for closing the supply port 224, the compression coil spring 246 is contracted by the flow pressure of the cleaning liquid 214, and the connection portions 64 of the O-ring valve 60 are extended by the flow pressure. Further, the valve body 66 is separated from the supply port 224. Thus, the cleaning liquid 214 flows into the water passage 242 through the flow passage 68 of the O-ring valve 60, and is discharged from the discharge port 240 to the discharge hose 228. The discharged cleaning liquid 214 is injected to the windshield from the washer nozzle 230 through the discharge hose 228, so that the windshield is washed. Here, the closing force of the valve body 66 for closing the supply port 224 includes elastic force of the connection portions 64 of the O-ring valve 60 and biasing force of the compression coil spring 246.

When the washer pump 212 is stopped, acceleration force is applied to the cleaning liquid 214 stored in the supply hose 208, the joint body 202 and the discharge hose 228 due to vibrations of a vehicle and its turn, and the cleaning liquid 214 may leak from the washer nozzle 230. However, as in the first embodiment, when the washer pump 212 is stopped, the cleaning liquid 214 is not supplied to the supply port 224, and the valve body 66 closes the supply port 224, thereby preventing the cleaning liquid 214 from flowing from the supply port 224 into the water passage 242. Therefore, when the washer pump 212 is stopped, the cleaning liquid 214 can be prevented from leaking from the washer nozzle 230. Further, in the second embodiment, the cleaning liquid 214 can be maintained in a state where the cleaning liquid 214 is filled in the joint body 202, the discharge hose 228 and the washer nozzle 230. That is, the supply port 224 is closed by the valve body 66 of the O-ring valve 60, so that air can be prevented from flowing from the washer nozzle 230 into the discharge hose 228, the joint body 202 and the supply hose 208. Therefore, when the washer pump 212 is started again and the cleaning liquid 214 is press-sent, the valve body 66 is immediately separated from the supply port 224 to open the supply port 224. Thus, a passed time, from the start of the washer pump 212 to the cleaning liquid discharge from the discharge port 240 man be made very short, thereby improving discharge responsibility. The discharge responsibility is defined by shortness of a passed time from injection command operation to the cleaning liquid discharge. Further, a passed time, from the start of the washer pump 212 to the cleaning liquid injection from the washer nozzle 230 can be made very short, thereby improving the injection responsibility.

The joint body 202 is formed by assembling the supply body portion 204 having the supply port 224 and the discharge body portion 206 having the discharge port 240 with each other. The supply body portion 204 and the discharge body portion 206 are attached to each other by the insert of the joint portion 232 into the joint hole 216 and by engagement of the engagement protrusions 236 in the engagement holes 226. At this time, the fixing portion 62 of the O-ring valve 60 is clamped and fixed between the bottom surface of the joint portion 232 and the bottom surface of the joint hole 216, so that the attachment portion between the joint hole 216 of the supply body portion 204 and the joint portion 232 of the discharge body portion 206 are sealed. Therefore, the supply body portion 204 and the discharge body portion 206 are not required to be bonded by ultrasonic welding and the like. Without this bonding, the O-ring valve 60 can be fixed into the joint body 202 through the fixing portion 62 while seal performance in the joint body 202 can be ensured. Thus, even after the supply body portion 204 and the discharge body portion 206 are assembled with each other, they can be disassembled from each other by disengaging the engagement protrusions 236 from the engagement holes 216 and by detachment of the joint portion 232 from the joint hole 216. Accordingly, the check valve 244 and the like in the joint body 202 can be maintained and repaired. For example, foreign matters clogged in the water passage 242 and the supply passage 222 can be removed in the maintenance. That is, a portion of components constructing the hose joint 200 can be exchanged, and the other components can be used as they are without discarding all of the hose joint 200.

When the supply body portion 204 and the discharge body portion 206 are assembled with each other, the engagement protrusions 236 are engaged with the engagement holes 226, and the fixing portion 62 is elastically deformed to be fitted and clamped between the top surface of the joint portion 232 and the bottom surface of the joint hole 216. Therefore, the fixing portion 62 can be accurately fixed in the joint body 202 while surely sealing the attachment portion between the supply body portion 204 and the discharge body portion 206 due to the elastic deformation of the fixing portion 62. The engagement protrusions 236 can be engaged with the engagement holes 226 without a movement due to restoring force of the elastic deformation of the fixing portion 62. Therefore, the supply body portion 204 and the discharge body portion 206 can be assembled with each other without a movement. The deformation state, where the fixing portion 62 is elastically deformed to be fitted and clamped, can be maintained due to the engagement between the engagement protrusions 236 and the engagement holes 226. Therefore, the sealing performance of the joint body 202 can be maintained while the attachment state of the O-ring valve 60 can be maintained.

The fixing portion 62 of the O-ring valve 60 is clamped and fixed between the bottom surface of the joint hole 216 of the supply body portion 204 and the top surface of the joint portion 232 of the discharge body portion 206 at a position displaced toward the supply body portion 204 from the contact position B between the valve body 66 and the valve seat 220, by the dimension Dt. In this case, since the connection portions 64 of the O-ring valve 60 are extended, the valve body 66 can be pressed to the valve seat 220 due to contraction force of the connection portions 64. When the valve body 66 contacts the valve seat 220 around the supply port 224, the valve body 66 is fitted to the top end shape of the valve seat 220 and the peripheral shape of the supply port 224, due to the contraction of the valve body 66. Accordingly, the supply port 224 can be surely closed, and the cleaning liquid 214 can be surely prevented from flowing from the supply port 224 into the water passage 242 when the washer pump 212 is stopped. Since the valve body 66 of the O-ring valve 60 contacts the valve seat 220 protruding around the supply port 224, line contact can be substantially set between the valve seat 220 and the valve body 66. Therefore, between the valve seat 220 and the valve body 66, contact pressure is increased, and fit performance is improved. Thus, the supply port 224 can be more surely closed, and the cleaning liquid 214 can be more surely prevented from flowing from the supply port 224 into the water passage 242 when the washer pump 212 is stopped.

Since the compression coil spring 246 presses the valve body 66 toward the supply port 224, the supply port 224 can be more rapidly and accurately closed by the valve body 66. Since the fixing portion 62 of the O-ring valve 60 has a sealing function for the joint body 202, a conventional O-ring used for only sealing is not required. Therefore, the number of components and the number of assembling processes of the check valve 244 can be reduced, thereby reducing production cost.

Further, in the second embodiment, the supply port 224 can be opened and closed by the O-ring valve 60 without using the compression coil spring 246. In this case, the check valve 244 can be constructed by only the O-ring valve 60.

Although the present invention has been fully described in connection with the preferred embodiments thereof with reference to the accompanying drawings, it is to be noted that various changes and modifications will become apparent to those skilled in the art.

For example, in the above-described first embodiment of the present invention, the valve device with the check valve is typically used for the washer nozzle 10 for jetting the cleaning liquid toward the windshield. Further, in the above-described second embodiment of the second embodiment, the valve device with the check valve is typically used for the hose joint 200 for joining the hoses. However, the present invention can be applied to other devices without being limited to the washer nozzle and the hose joint.

Such changes and modifications are to be understood as being within the scope of the present invention as defined by the appended claims.

What is claimed is:

1. A washer nozzle for jetting a cleaning liquid, the washer nozzle comprising:
a nozzle body including
a first body portion and a second body portion which are attached to each other, the first body portion having a supply port from which the cleaning liquid is supplied into the nozzle body, and the second body portion having a discharge port from which the cleaning liquid is discharged, and
a fluid passage through which the supply port and the discharge port communicate with each other; and
a check valve disposed in the fluid passage, for preventing the cleaning liquid from flowing from the fluid passage into the supply port and for enabling the cleaning liquid to flow from the supply port into the fluid passage, wherein the check valve includes
an annular fixing portion clamped and fixed between the first body portion and the second body portion attached to each other, for sealing an attachment portion between the first body portion and the second body portion,
a plurality of connection portions extending from the fixing portion toward a radial inside of the fixing portion at plural positions of the fixing portions,
a valve body connected to the connection portions, for closing the supply port by contacting a periphery of the supply port, the valve body capable of being separated from the supply port by a flow pressure of the cleaning liquid supplied from the supply port, larger than a predetermined pressure, and
a flow passage that is provided to penetrate through the check valve.

2. The washer nozzle according to claim 1, wherein the flow passage is provided between the fixing portion, the connection portions and the valve body.

3. The washer nozzle according to claim 1, further comprising
a spring, disposed in the fluid passage, for pressing the valve body toward the supply port.

4. The washer nozzle according to claim 1, wherein the fixing portion, the connection portions and the valve body are integrally formed from an elastic material.

5. The washer nozzle according to claim 1, wherein:
the first body portion includes a first engagement portion;
the second body portion includes a second engagement portion being engaged with the first engagement portion; and
when the first body portion and the second body portion are attached to each other, the first engagement portion and the second engagement portion are engaged with each other, and the fixing portion is elastically clamped and fixed between the first body portion and the second body portion.

6. The washer nozzle according to claim 1, wherein:
the first body portion includes a valve seat around the supply port; and
the supply port is closed when the valve body contacts the valve seat.

7. The washer nozzle according to claim 6, wherein the fixing portion is clamped and fixed between the first body portion and the second body portion at a position displaced toward the first body portion with respect to a contact position at which the valve body contacts the valve seat in an axial direction of the fluid passage.

8. The washer nozzle according to claim 1, wherein the first body portion and the second body portion are detachably attached to each other.

9. A hose joint comprising:
a joint body for joining a supply hose and a discharge hose, the joint body including
a first body portion and a second body portion which are attached to each other, the first body portion including a supply port from which a liquid fluid is supplied into the joint body, the supply port being connected to the supply hose, the second body portion including a discharge port from which the liquid fluid is discharged, the discharge port being connected to the discharge hose, and
a fluid passage through which the supply port and the discharge port communicate with each other; and
a check valve disposed in the fluid passage, for preventing the liquid fluid from flowing from the fluid passage into the supply port and for enabling the liquid fluid to flow from the supply port into the fluid passage, wherein the check valve includes
an annular fixing portion clamped and fixed between the first body portion and the second body portion attached to each other, for sealing an attachment portion between the first body portion and the second body portion,
a plurality of connection portions extending from the fixing portion toward a radial inside of the fixing portion at plural positions of the fixing portions,
a valve body connected to the connection portions, for closing the supply port by contacting a periphery of the supply port, the valve body capable of being separated from the supply port by a flow pressure of the fluid supplied from the supply port, larger than a predetermined pressure, and
a flow passage that is provided to penetrate through the check valve.

10. The hose joint according to claim 9, wherein the flow passage is provided between the fixing portion, the connection portions and the valve body.

11. The hose joint according to claim 9, further comprising
a spring disposed in the fluid passage, for pressing the valve body toward the supply port.

12. The hose joint according to claim 9, wherein the fixing portion, the connection portions and the valve body are integrally formed from an elastic material.

13. The hose joint according to claim 9, wherein:
the first body portion includes a first engagement portion;
the second body portion includes a second engagement portion being engaged with the first engagement portion; and
when the first body portion and the second body portion are attached to each other, the first engagement portion and the second engagement portion are engaged with each other, and the fixing portion is elastically clamped and fixed between the first body portion and the second body portion.

14. The hose joint according to claim 9, wherein:
the first body portion includes a valve seat around the supply port; and
the supply port is closed when the valve body contacts the valve seat.

15. The hose joint according to claim 14, wherein the fixing portion is clamped and fixed between the first body portion and the second body portion at a position displaced toward the first body portion with respect to a contact position at which the valve body contacts the valve seat in an axial direction of the fluid passage.

16. The hose joint according to claim 9, wherein the first body portion and the second body portion are detachably attached to each other.

17. A valve device comprising:
a body member for defining a fluid passage through which a liquid fluid flows, the body member including a first body portion and a second body portion which are attached to each other, the first body portion having a supply port from which the liquid fluid is supplied into the body member, the second body portion having a discharge port from which the liquid fluid is discharged from the body member; and
a check valve disposed in the fluid passage, for preventing the liquid fluid from flowing from the fluid passage into the supply port and for enabling the liquid fluid to flow from the supply port into the fluid passage, wherein:
the supply port and the discharge port communicate with each other through the fluid passage; and
the check valve includes
a fixing portion generally having a circular shape, the fixing portion being clamped and fixed between the first body portion and the second body portion attached to each other, for sealing an attachment portion between the first body portion and the second body portion,
a plurality of connection portions extending from the fixing portion toward a radial inside of the fixing portion at plural positions of the fixing portions,
a valve body connected to the connection portion to be supported by the connection portions, for closing the supply port by contacting a periphery of the supply port, the valve body capable of being separated from the supply port by a flow pressure of the liquid fluid supplied from the supply port, larger than a predetermined pressure, and
a flow passage that is provided to penetrate through the check valve.

18. The valve device according to claim 17, wherein the connection portions are provided between the fixing portion and the valve body to be elastically deformed between the fixing portion and the valve body.

19. The valve device according to claim 17, wherein the flow passage is provided between the fixing portion, the connection portions and the valve body.

20. The valve device according to claim 17, further comprising
an elastic member, disposed in the fluid passage to be elastically deformed, for pressing the valve body toward the supply port, wherein:
one end of the elastic member is connected to the valve body, and the other end of the elastic member is connected to the second body portion; and
the elastic member is a spring member.

21. The valve device according to claim 17, wherein the fixing portion, the connection portions and the valve body are integrally formed from an elastic material.

22. The valve device according to claim 17, wherein:
the first body portion includes a first engagement portion;
the second body portion includes a second engagement portion being engaged with the first engagement portion; and
when the first body portion and the second body portion are attached to each other, the first engagement portion and the second engagement portion are engaged with each other, and the fixing portion is elastically clamped and fixed between the first body portion and the second body portion.

23. The valve device according to claim 17, wherein:
the first body portion includes a valve seat around the supply port; and
the supply port is closed when the valve body contacts the valve seat.

24. The valve device according to claim 23, wherein the fixing portion is clamped and fixed between the first body portion and the second body portion at a position displaced toward the first body portion with respect to a contact position at which the valve body contacts the valve seat in an axial direction of the fluid passage.

25. The valve device according to claim 17, where in the first body portion and the second body portion are detachably attached to each other.

26. The valve device according to claim 17, wherein the body member is provided in a washer nozzle having a jet port from which the liquid fluid is jetted.

27. The valve device according to claim 17, wherein:
the first body portion is connected to a supply hose through which the liquid fluid is supplied to the supply port;
the second body portion is connected to a discharge hose into which the liquid fluid from the discharge port flows; and
the supply hose and the discharge hose is coupled to each other through the body member.
